(19) United States
(12) Patent Application Publication
(10) Pub. No.: US 2019/0021278 A1
(43) Pub. Date: Jan. 24, 2019

(54) SYSTEM FOR FEEDING LIVESTOCK AND ROBOT

(71) Applicant: Trioliet B.V., Oldenzaal (NL)

(72) Inventor: Cornelis Liet HENDRICUS, Losser (NL)

(21) Appl. No.: 16/031,776

(22) Filed: Jul. 10, 2018

(30) Foreign Application Priority Data
Jul. 21, 2017 (DE) 202017104377.0

(51) Int. Cl. A01K 5/02

(52) U.S. Cl. CPC A01K 5/0275; A01K 5/001; A01K 5/0208; A01K 5/0291

(57) ABSTRACT

A livestock feeding system with a feed preparation area containing at least one storage, a livestock stable which is connected via driving routes to the feed preparation area, and a robot which comprises a variable speed electric drive controllable by a frequency transformer and a battery, and which is optionally connectable to a power supply at least in the feed preparation area, is a power rail line in the feed preparation area routed past the storages and a docking device to the power rail line. The robot contains a high-voltage DC battery which is connected to an intermediate circuit of the frequency transformer.

### FIELD OF THE INVENTION

The invention relates to a system suitable for feeding livestock, and to a robot system for feeding livestock.

### BACKGROUND OF THE INVENTION

As a feeding robot, the robot, autonomously driving in the system between the storages and the stables, must mix well and quickly and possibly cut the feed loaded, should it not be loaded premixed in the robot used as distributing robot. Considerable electrical power is required, especially for mixing. A robot with a loading capacity of approx. 3 m³ requires about 11 KW at a feed density of about 350 kg/m³. Considerable electrical power is required also for self-driving either via a suspension rail or on a chassis also to and from the dispensing points and for dispensing e.g. using a lateral pusher, dispensing rollers and/or by way of a cross conveyor belt. The robot performs, for example, 35 cycles per day. Due to the high power demand, a single docking device predetermined in its location has in prior art previously been installed in the feed preparation area, and/or all driving routes are equipped with power rails also in the stables. However, if the system comprises several buildings, then the power rail must also be installed among the buildings, obstructing the traffic in the system and causing extreme costs for the supporting structures. In addition, seeing many power rails sections and their suspensions outside of buildings is unsightly.

### SUMMARY OF THE INVENTION

The invention is based on the object of providing a system of the kind mentioned above and a robot that enable energy-efficient operation.

This object posed is satisfied by the features of the claims.

Since a power rail line extending along the storages is provided with at least one docking device as an entry or exit point for the robot at least in the feed preparation area, filling can be done efficiently and, if necessary, feed can be mixed everywhere in the entire region of the feed preparation area without use of the battery. Mixing and blending is in fact the job with the highest power consumption. While work is being carried out at or in the robot in the feed preparation area and can possibly be supplied with power from the power rail line, the battery can simultaneously be charged or topped up everywhere. The robot then does not need to be located at a predetermined position, but it is connected substantially permanently to the power rail line during work. Once the robot has completed e.g. its mixing work or has been loaded, it drives autonomously along the driving routes and to and into the stable for dispensing, where the driving and the dispensing operation can be done with electricity from the battery which was already fully charged in the feed preparation area. The charging device can be located in the robot, and/or one or more charging devices are located in a stationary manner and connected to the power rail line.

The robot is either a feeding robot, which can have two mixing elements in the container, mix the feed automatically and optionally cut and dispense it in a rotational speed-controlled manner, or a distributing robot, which is loaded with feed or even already mixed feed in the container and dispenses it e.g. without speed control.

Several docking devices and/or power rail lines can even be installed in the feed preparation area.

Instead of 12 V or 24 V batteries with standard low voltage, the robot comprises at least one high-voltage battery which is connected at least on the output side to the respective intermediate circuit of the frequency transformer. The high-voltage battery and the frequency transformer provided for rotational speed control of the electric drive allow the use of highly efficient electric motors that are relatively inexpensive and deliver high performance, where the connection of the battery to the circuit entails the significant advantage of being able to omit expensive and heavy converters, and supply the electric drive directly via the intermediate circuit of the frequency transformer during battery operation with high DC output voltage of the battery. In addition to the power rail line in the feed preparation area, at least one further power rail line with at least one docking device can be provided in at least one stable. This power rail line in the stable does not necessarily need to span the entire feeding lane, but only to ensure that the robot is temporarily connected to the power rail line at least when visiting or when leaving the dispensing points and recharges the battery in order to be able to operate with full battery power, for example, when dispensing. A respective confined power rail line with a docking device can also be provided in the system also for other external storages for feed or feed additives.

Sections of the driving route between the feed preparation area and the respective stable are advantageously clear of power rail lines and docking devices, so that this open area is easily accessible for other traffic and is not obstructed by a power rail line and its suspensions.

The transmission of the operating, working and/or charging current from the power rail line to the robot can be galvanic, for example, using current collectors configured as sliding contacts, or also without contact.

Each docking device can comprise an entry guide or a forced steering system for the robot, preferably its current collector. Current collectors are advantageously each provided in duplicate in order to always ensure contact at switches or the like. Instead of or in addition to an entry guide, it is possible to configure the current collector or current collectors to be resiliently movable in order to ensure a proper docking operation.

In order to be able to use a powerful electric drive and save additional expensive equipment, such as converters, it is advantageous to have the power rail line provide three-phase current with at least approximately 230 VAC, preferably approximately 400 VAC, for the frequency transformer of the electric drive and possibly for the battery charging device, where the electric drive can advantageously have a synchronous or asynchronous motor which can be operated in star or delta connection. If only 230 V single-phase current is available in the grid, then it is converted to three-phase current for the power rail line.

A particularly important aspect of the invention with independent significance is that the respective battery is a high-voltage battery with high DC output voltage for the intermediate circuit of the frequency transformer. Particularly suitable are nickel/metal hydride batteries or lithium batteries or nickel-cadmium batteries (LiNiMnCo or LiMnCo for example), the advantages of which are a high charging capacity and rapid charging processes. Direct current can be supplied alternatively from other high-voltage batteries suitable for this purpose.

In order to save expensive converters, it is particularly important to connect the high-voltage battery on the output side to an intermediate circuit of at least one, preferably all frequency transformers comprising an AC primary circuit connectable to the power rail line, the DC intermediate circuit, and an AC secondary circuit connectable to the electric motor.

It is there advantageous to have the DC output voltage of the battery to be higher by a factor of >1, preferably theoretically by 1.41 (root of 2), than the alternating voltage from the power rail line acting upon the primary circuit of the frequency transformer. This increasing factor allows battery B to deliver an increased DC output voltage with which motor control is efficiently effected in the intermediate circuit of the respective frequency transformer.

Three-phase AC current at 400V, 50 Hz that can be supplied to the primary circuit of the frequency transformer is often available in Europe. The DC voltage in the intermediate circuit of the frequency transformer is then approximately 564V (factor about 1.41). With six or a multiple of six 96-volt batteries, approximately 576 volts, with full batteries even up to about 680 volts, are then available for use. The electric motor is operated in star connection. In the US and Canada, three-phase current at 230 volts, 60 Hz, is often available in three phases for the supply to the primary circuit. Direct current at about 324 volts is applied to the intermediate circuit. With three or a multiple of three 108-volt batteries, at least approximately 324 volts are usable. The electric motor is operated in delta connection. The same electric motors can then be used in the robots in both market sectors.

The voltage values mentioned are non-restricting theoretical examples. The DC voltage supplied to the intermediate circuit can vary in practice, e.g. be higher by about 10%.

In order to charge the high-voltage battery without a separate charging device, it is advantageous to connect the battery via a separate charging line to the intermediate circuit of at least one frequency transformer, monitored e.g. by a switch or a relay. Suitable for this purpose is, e.g. the frequency transformer of an electric drive that is not constantly in operation.

Another important aspect is that the docking device comprises a safety circuit, with which low voltage up to, for example, a maximum of 48 V is provided until the robot is substantially fully docked, and which is switched to three-phase current only with full docking. This safety circuit prevents live parts from being contacted during the docking process for reasons of accident or vandalism, which would cause damage or injury to people.

The feeding robot advantageously comprises electric drives for mixing elements, for driving and/or steering wheels and for at least one dispensing device. The electric drives can comprise only electric motors, but also gears such as planetary gears and the like, for example, to be able to produce low driving rotational speeds with high torques at efficient high output rotational speed of the electric motor.

Since the mixing elements of the feeding robot and the dispensing device have a relatively high power demand, especially when dispensing, it is advantageous to assign each mixing element its own variable-speed electric drive, or equip both mixing elements with a common electric drive having a drive train with a clutch between the mixing elements. These solutions are particularly advantageous in terms of energy usage. It is a fact that the torque of, for example, a vertical mixing auger as a mixing element depends strongly on the auger diameter. With a container content of, for example, 2.5 or 3 m³, it is therefore advantageous to equip two mixing elements with smaller diameters of about 80 cm, as compared to a container of the same size with a single mixing auger of about 1.5 m in diameter. This also applies to larger containers of, for example, 10 or 12 m³. Because dispensing can then be commenced by first driving only one mixing element until the associated part of the mixing chamber in the container is almost empty. Only then is the other mixing element driven. It is then not necessary to take the total content from 0 to dispensing speed, but only one, and then with a time delay, the second mixing element is instead switch on once the container content has reduced. It is also possible to proceed in such a way that the second mixing element first conveys feed to the first mixing element and is then switched off again, etc., until the content in the rear part of the container does not significantly differ from the content of the front part at the end of the dispensing cycle. Both mixing elements can then be driven permanently, while requiring only low drive torques. The dispensing process should namely be done with the lowest possible rotational speed, for example, of about 15 to 20 rpm. However, in order not to hurl out the remaining feed, the rotational speed at the end of the dispensing cycle must increase up to, for example, 50 rpm, which is possible by use of the respective frequency transformer, but alternatively also by use of a shiftable gear.

In one advantageous form of the feeding robot, a control is provided for the mixing elements and possibly for the dispensing device with which only one of the mixing elements or both is or can be respectively driven and controlled in terms of rotational speed in dependence of operating parameters provided by sensors. Such operating parameters can be the respective power demand, the loading weight in the container, the filling level in the container or the dispensing quantity per unit time, or similar significant operating parameters.

In one advantageous embodiment of the system, the driving routes of the robot are predetermined by a guide rail network, preferably with switches and branch-offs, like the power rail network of the power rail lines.

The respective power rail line is installed in a stationary manner approximately parallel to the ground and slightly above the container of the robot, so that the driving motions of the robot are not obstructed and it still obtains easy access to the power supply.

In one advantageous embodiment of the robot, namely of the feeding robot or the distributing robot, the battery is a high-voltage battery operable with a high DC output voltage. Particularly suitable high-voltage batteries are inexpensive and high-performance nickel/metal hydride or lithium or nickel/cadmium batteries that can be employed for a long time in this application. Alternatively, other types of high voltage batteries can be used.

### BRIEF DESCRIPTION OF THE DRAWINGS

Embodiments of the object of the invention are explained with reference to the drawings, where

FIG. 1 shows a schematic top view of a system suitable for feeding livestock using an autonomously driving robot,

FIG. 2 shows an embodiment of a feed preparation area in a perspective view,

FIG. 3 shows another embodiment of a feed preparation area in a perspective view,

FIG. 4 shows a sectional view of an embodiment of a robot configured as a feeding robot,

FIG. 5 shows another embodiment of a feeding robot in a longitudinal sectional view,

FIG. 6 shows a circuit diagram of an embodiment of a robot connected to a power rail line, and

FIG. 7 shows a further circuit diagram similar to that of FIG. 6.

### DESCRIPTION OF THE PREFERRED EMBODIMENTS

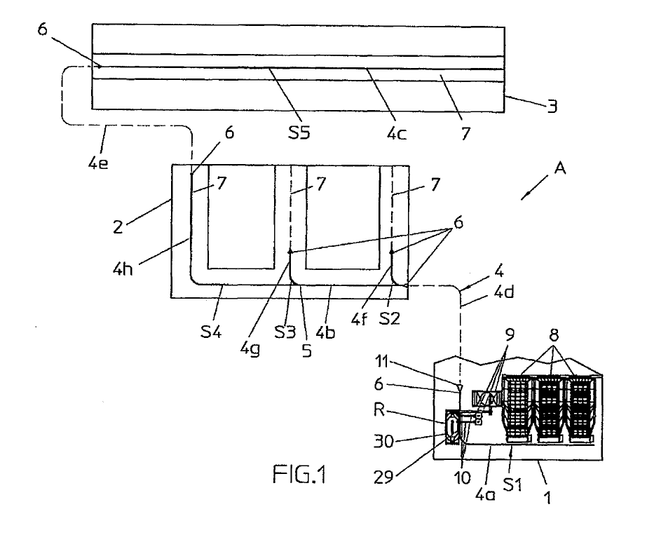

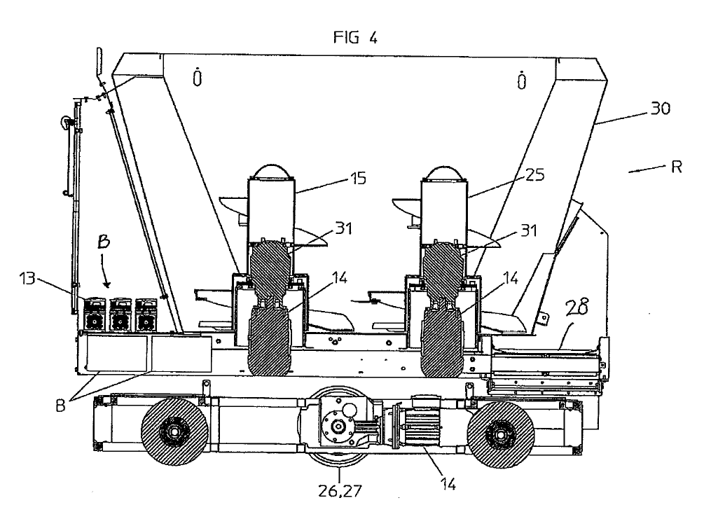

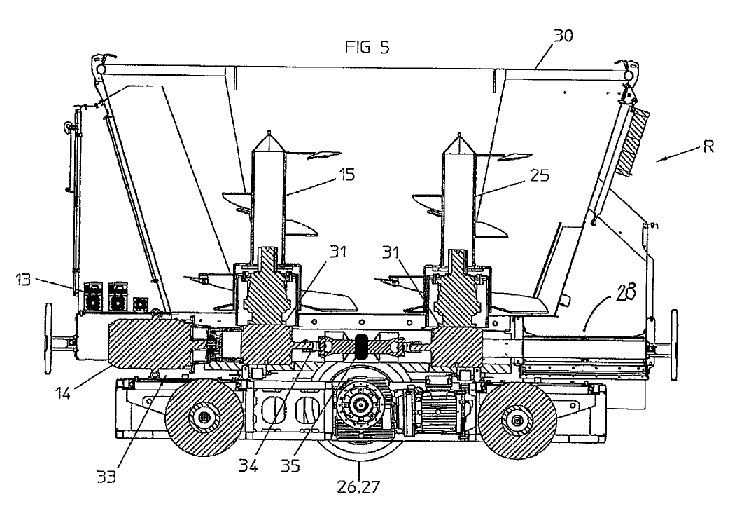

FIGS. 1, 2 and 3 schematically show a system A for feeding livestock using a robot R which is shown in FIGS. 4 and 5 in two possible non-restricting embodiments of a feeding robot, each in a longitudinal sectional view.

System A is electrically operable and energetically highly efficient because robot R can visit several points in at least one feed preparation area 1 where it has three-phase current available, e.g. in order to perform work with high power demand such as mixing and cutting feed with three-phase current and then always top up or recharge or fully charge at least one onboard battery, where battery B is advantageously a high-performance high-voltage battery such as a nickel/metal hydride battery or a lithium battery or a nickel/cadmium battery or a so-called traction battery with stacked films. The three-phase current, high-voltage battery B, and the power supply available at several points in combination with high-performance variable-speed electric motors in electric drives 14 of the components of robot R enable failure-free continuous operation under optimum conditions, which contributes to the energy efficiency of system A.

Feed preparation area 1 is shown in FIG. 1 as a non-restricting example of such a system A and in the illustrated embodiment is associated with two stables 2, 3 at distances from feed preparation area 1. Stable 2 houses, for example, high-performance dairy cattle, while stable 3 houses other livestock. The livestock in stable 2 requires, for example, more feed or feed of better quality than the livestock in stable 3. Both stables 2, 3 are cyclically visited by robot R in order to supply the livestock as respectively needed, where the feed is composed and mixed in feed preparation area 1. Feed preparation area 1 is connected to stables 2, 3 via a driving route 4 in connection, for example, with guide rails, suspension rails or loops installed in the ground. Robot R is either a feeding robot according to FIGS. 4-7 or a distributing robot (not shown) that can be loaded with feed or even already mixed feed.

Several feed preparation areas 1 or more storages 8, 9 than shown in FIGS. 1-3 can be provided in or at feed preparation area 1, as shown, and more or less than two stables 2, 3. In the embodiment shown, three storages 8 are provided in feed preparation area 1 adjacently for different types of feed, as well as a storage 9 formed from bunkers, for example, for additives.

Driving route 4 leads past storages 9, 8 in feed preparation area 1, in a presently angled manner. Loading facilities, not shown, can be used for loading robot R. Storage 8 can comprise e.g. three additional bunkers, one e.g. for a large amount of spent grains/sugar beet shred and two mineral dispensers 9 for flours or salts, each with an outlet auger 10.

provided in feed preparation area 1 is a section 4a of the driving route along which a power rail line S1 extends with at least one docking device 6, via which electrically operated robot R is able to dock onto power rail line S1 and then travel along power rail line S1, or undock from power rail line S1 and then move electrically by way of battery B to a section 4d toward stable 2. Robot R is in feed preparation area 1 presently standing or driving to storage 9 in order to there be loaded by way of a supply device or output auger 10. Of robot R, a container 30 is visible and at least one current collector 29 for the electrical connection to power rail line S1. The power transmission to robot R can be galvanic, e.g. with a sliding contact, and two current collectors 29, or alternatively contactless by way of induction. Furthermore, FIG. 1 indicates an insertion guide 11 at docking device 6 via which current collectors 29 of robot R are reliably guided into docking device 6. Alternatively, a forced steering device could there be provided, or the current collector or current collectors 29 could be resiliently correctable to ensure the exact coupling between robot R and power rail segment or line S1.

Indicated in stable 2 as a non-restricting example are three feeding lanes 7 substantially parallel to each other, and a longitudinal end-to-end feeding lane 7 in stable 3 The livestock to be fed can stand on both sides of the respective feeding lane 7, or on one side.

In addition to power rail line S1 in feed preparation area 1 in stable 2, further power rail lines S2, S3 and S4 are installed in FIG. 1 as an option, advantageously, as in feed preparation area 1, on supports or suspensions, not shown, and substantially parallel to the ground and slightly above container 30 of robot R. Power rail lines S2, S3 and S4 are linked to each other by switches 5. Starting out from a docking device 6, power rail line S2 runs, for example in an arc over approximately 90° and along a section 4f of driving route section 4a leading to the end of feeding lane 7, and up to a further docking device 6 at a distance from the end of feeding lane 7. A further power rail line S4 furthermore runs along a section 4b of the driving route perpendicular to feeding lanes 7 in stable 2, from which a power rail line S3 branches off via a switch 5 into the center feeding lane 7 and which runs along a section 4h of driving route 4 leading to the rear exit of stable 2 and along a power rail line S4. A further docking device 6 is installed in the region of the rear exit from stable 2 to a section 4 of driving route 4e. No power rail lines are installed along sections 4d and 4e of driving route 4, for example, for the reason that this is free terrain of system A. Finally, a further power rail line S5 is optionally provided in stable 3 along feeding lane 7 over its entire length and comprises a further docking device 6.

As mentioned, further power rail lines S2, S3, S4 and S5 are options and not necessarily required. Alternatively, further power rail lines can be installed in other external storages or facilities of the system (not shown), such as silos or the like, i.e. not in open terrain, but at or in given structures, and each be installed with at least one docking device.

The driving operation of robot R in sections, for example, 4d, 4e and over a portion of sections 4f and 4g is effected by battery B, whereas the supply form the grid can be provided in the illustrated embodiment along power rail lines S2, S3, S4 and S5. When supplying power from the grid, battery B can be continuously topped up or fully charged. It is of course possible to equip robot R with several batteries B. Furthermore, system A can use more than one robot R which can either travel one behind the other or cross each other.

It is also conceivable not to let robot R travel back from the end of feeding lane 7 in stable 3, as shown in the embodiment, but it would then be possible to provide a further section of driving route 4 so that the robot returns from stable 3 directly to feed preparation area 1.

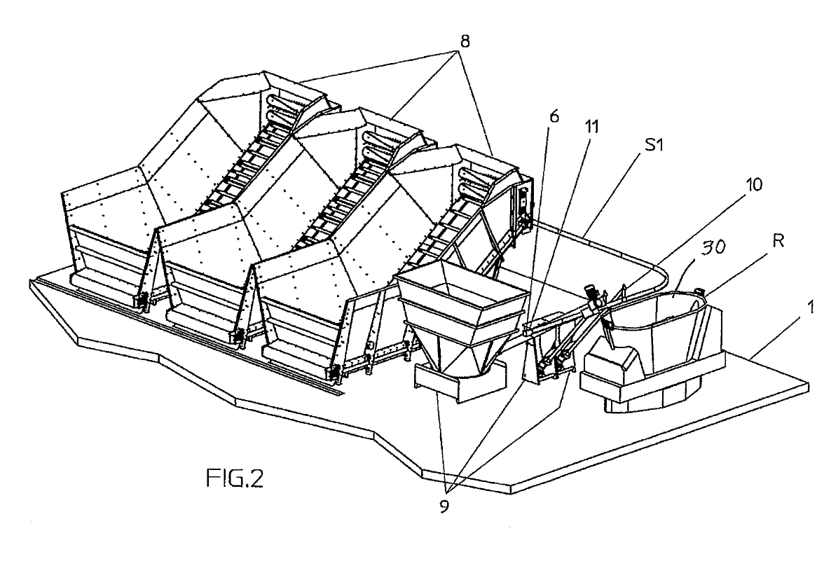

FIG. 2 illustrates in a perspective view of feed preparation area 1 of FIG. 1 with three storages 8 which are arranged in parallel to each other, and storage 9 formed as a bunker 9 with its supply devices 10. Power rail line S1 is further shown which presently extends bent by 90° along storage 9 and along storage 8. Suspensions or ground supports of power rail line S1 are not indicated in FIG. 2.

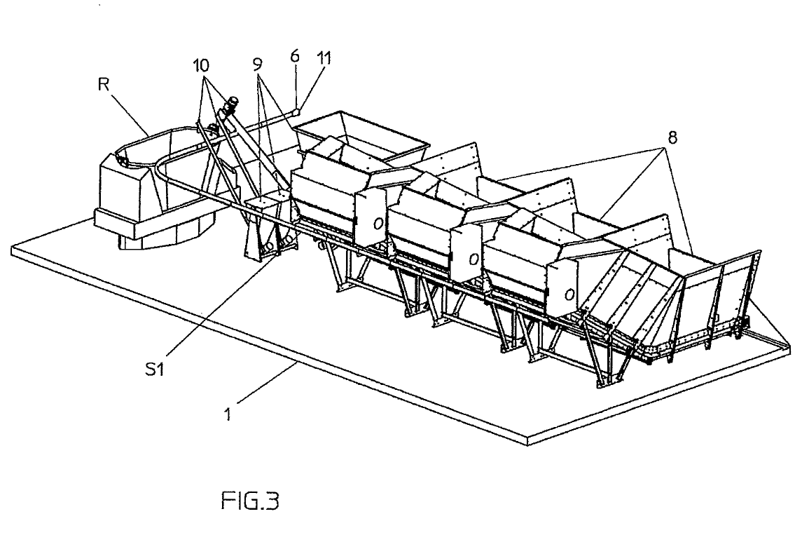

FIG. 3 shows another embodiment of a feed preparation area 1, presently again with three parallel storages 8 and storage 9 as well as power rail line S1 which covers substantially entire feed preparation area 1 where robot R needs to drive to be loaded or to mix and cut the cargo. Mixing and cutting is work for robot R that entails the highest power consumption and is therefore advantageously supplied from the grid, where the battery B is respectively either topped up or fully charged.

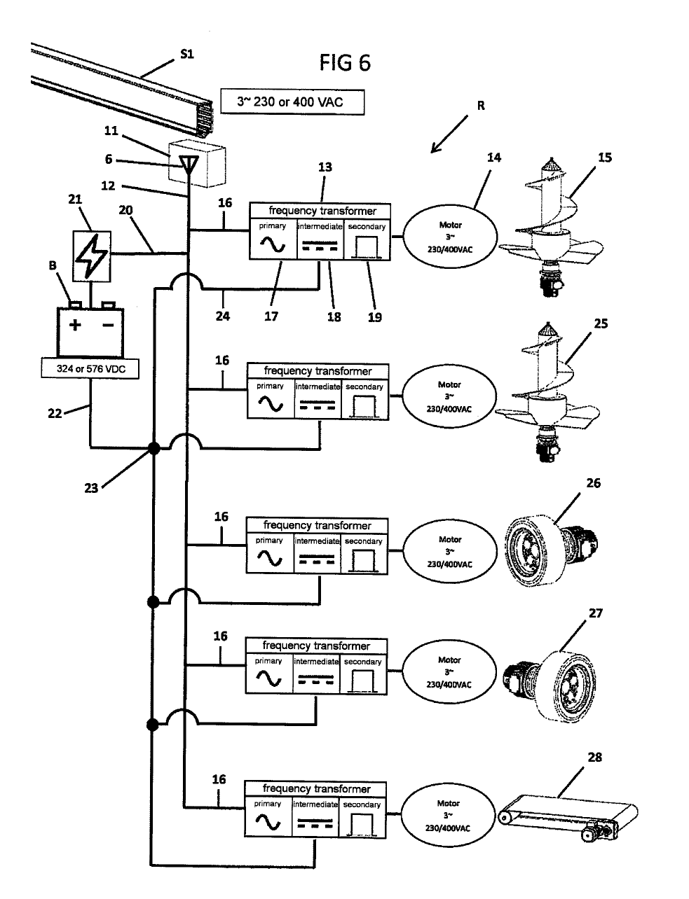

The longitudinal sectional view of feeding robot R in FIG. 4 shows oval-conical container 30 which rests on a chassis comprising, for example, driving and/or steering wheels 26, 27 with which the kinetic energy is transmitted to the ground when robot R drives. Installed in container 30 are optionally at least two mixing elements 15, 25 as vertical mixing augers, where each mixing element 15, 25 is driven by its own electric drive 14, for example, by way of a gear 31. Further electric drives 14 are provided for the driving and/or steering wheels 26, 27. Electric drives 14 advantageously contain synchronous or asynchronous motors in star or delta connection. The gears can be shift or planetary gears. Arranged in a secondary compartment of container 30 are, for example, several batteries B. Robot R comprises weighing devices and control devices not further specified, such as frequency transformers 13 shown in FIG. 6 for rotational speed control of electric drives 14. Furthermore, a controller can be provided to drive mixing elements 15, 25 together or individually.

Feeding robot R further comprises a dispensing device 28, for example, at least one slide arranged laterally on container 30 for closing and exposing a dispensing opening and one or more cross conveyor belts. In order to operate in an energy-efficient manner when dispensing in respective feeding lane 7, only one mixing element may be driven initially for dispensing when a container 30 is full (sampled by weight or filling sensors), while the other mixing element is stopped and only switched on when the filling level decreases in order supply the other mixing element while it continues dispensing or is temporarily stopped. If enough feed has been shifted, the mixing element presently not dispensing can again be shut down. In this manner, various methods for driving the mixing elements and possibly the dispensing device are possible, namely with regard to saving as much electrical energy as possible without impairing the dispensing operation.

The embodiment of feeding robot R shown in FIG. 5 differs from that of FIG. 4 primarily in that a common electric drive 14 is provided for the two mixing elements 15, 25 and drives a drive train 33 which extends to both mixing elements 15, 25 and which extends through gear 31 and contains an intermediate shaft 34 with at least one clutch 35 therebetween. This concept also makes it possible to operate both mixing elements 15, 25 simultaneously or alternately. Gears 31 are possibly switchable planetary gears for delivering different rotational speeds and/or torques to mixing elements 15, 25.

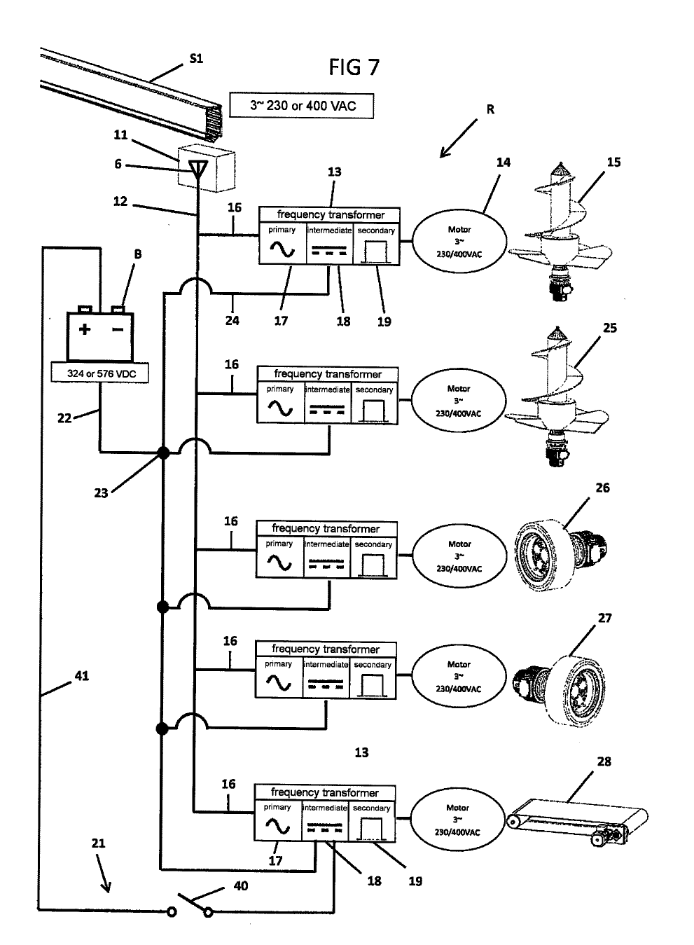

FIGS. 6 and 7 illustrate the electrical circuitry of feeding robot R in one embodiment with separate electric drives 14 for two mixing elements 15, 25, separate electric drives for wheels 26, 27, and an electric drive for a cross conveyor belt 28 as the dispensing device.

Feeding robot R in FIG. 6 has docked, for example, by way of docking device 6, to power rail line S1 in the feed preparation area and is supplied via a main line 12 with three-phase current of, for example, 400 VAC (400 V alternating current). A frequency transformer 13 is provided for each variable-speed electric drive 14 and connected via a branch line 16 to main line 12, and comprises an AC primary circuit 17, a DC intermediate circuit 18 and an AC secondary circuit 19. At least one branch line 20 leads from main line 12 to an on-board battery charging device 21, from where a line 22 leads via battery B to a node 23. Lines 24 lead from node 23 to each intermediate circuit 18 of a frequency transformer 13.

The at least one battery B is a high-voltage battery which due to system requirements is theoretically capable of delivering a DC current higher by a factor of >1, namely 1.41, presently at about 564 V, from the 400 VAC three-phase current.

Furthermore, a safety circuit is indicated as 11 in FIGS. 6 and 7, which, for example, ensures that only a low voltage of, for example, up to 48 V is transmitted in respective docking device 6, as long as live parts are still accessible from the outside, and only switches to the full three-phase current when current collectors 29, not shown in FIG. 6, of robot R have docked in such a manner that access to live components is no longer possible from the outside (accident protection).

As long as feeding robot R is in FIGS. 6 and 7 docked to power rail line S1 (or the other power rail lines S2 to S5) and is either stopped or drives, electric drives 14 can be supplied from the grid and battery B is topped up or fully charged at the same time. However, once feeding robot R has undocked from power rail line S1, electric drives 14 are operated using battery B, where battery B supplies high DC voltage to the respective intermediate circuit 18 from which the alternating voltage presently used for electric drive 14 is generated in secondary circuit 19.

Robot R drives autonomously, is automatically loaded, for example, mixes the feed during the dwelling time in feed preparation area 1, or even when visiting the respective feeding lane, and dispenses the feed for the livestock according to predetermined programming. If power rail line S1 is installed only in feed preparation area 1, then the driving operation and the dispensing takes place using battery B, however, if several power rail lines S1 to S5 are installed in the system, each with at least one docking device 6 except for the driving sections in open terrain as indicated for example in FIG. 1, then the driving and/or the dispensing operation can be done either using the battery or from the grid or in combination of these two power sources.

The circuit of feeding robot R shown in FIG. 7 differs from FIG. 6 by a variant of battery charging device 21, namely in that, instead of the on-board separate charging device 21 of FIG. 6, the high-voltage battery B for charging via its separate line 41 is connected and a switch/relay 40 to an intermediate circuit 18 of a frequency transformer 13, presently dispensing device 28, in order to tap high DC voltage for charging. An electronic boost circuit can there be used to optimize the charging process.

Feeding robot R carrying out the mixing and/or cutting operation with three-phase current was explained with reference to FIGS. 4-7. However, as part of system A, the invention also comprises one or more distributing robots R, not shown, which are each loaded with feed or already mixed feed in feed preparation area 1. Compared to FIGS. 4-7, mixing elements 15, 25 and their drives are omitted in distributing robot R. Distributing robot R can optionally contain a dispensing device not comprising variable speed electric drives. However, at least one variable speed electric drive 14 with a frequency transformer 13 is provided for autonomous driving, at the DC voltage intermediate circuit 18 of which the high-voltage battery B is connectable.

FIG. 6 shows a detail variant in dashed lines. Instead of an on-board charging device 21 of robot R, at least one stationary charging device 21 is there provided which feeds battery B with DC via a charging line that is separate from main line 12 when robot R is docked.

What is claimed is:

1. A system suitable for feeding livestock with at least one feed preparation area containing several storages for feed and/or additives, at least one livestock stable containing feed dispensing areas and being connected to at least one said feed preparation area via robot driving routes, and at least one electrically operable autonomously driving robot with at least one variable speed electric drive controllable by a frequency transformer, at least one battery chargeable with a battery charging device, said robot being connectable at least in said feed preparation area by way of at least one current collector to a power supply, wherein a power rail line routed past said several storages and at least one docking device defining a robot entry point into and a robot outlet point from said power rail line is provided at least in said feed preparation area, where said power rail line extends substantially over an entire area in said feed preparation area within which said robot is at least loaded.

2. The system according to claim 1, wherein said robot is a self-mixing feeding robot that is loadable at least in said feed preparation area with feed in a container.

3. The system according to claim 2, wherein said feeding robot has at least two mixing elements in said container.

4. The system according to claim 1, wherein said robot is a distributing robot which is loadable at least in said feed preparation area with already premixed feed in a container.

5. The system according to claim 1, wherein several docking devices are provided at least in said feed preparation area.

6. The system according to claim 1, wherein at least one power rail line and at least one respective docking device on the former are additionally provided in at least one livestock-stable.

7. The system according to claim 1, wherein sections of said driving route between said feed preparation area and said respective stable are without power rail lines and docking devices.

8. The system according to claim 1, further comprising a galvanic or non-contact power transmission between said power rail line and said robot.

9. The system according to claim 1, wherein each docking device comprises an entry guide or a forced steering system for said robot, for its current collector.

10. The system according to claim 1, further comprising a three-phase power rail line for three-phase current with at least about 230 VAC for said frequency transformer of said electric drive and said battery charging device, where said respective electric drive comprises a synchronous and/or asynchronous motor operable in star or delta connection.

11. The system according to claim 1, wherein said battery in said robot is at least one high-voltage battery, preferably a nickel/metal hydride battery or a lithium battery or a nickel-cadmium battery.

12. The system according to claim 11, wherein said high-voltage battery is connectable at least on the output side to an intermediate circuit of at least one frequency transformer comprising an AC primary circuit, the DC circuit, and an AC secondary circuit.

13. The system according to claim 10, wherein the DC output voltage of said high-voltage battery is higher by a factor of >1, preferably by about 1.41, than the alternating voltage acting upon said primary circuit of said frequency transformer.

14. The system according to claim 1, wherein said charging device comprises a line containing a switch or a relay between said high-voltage battery and at least one intermediate circuit of a frequency transformer.

15. The system according to claim 1, wherein said docking device comprises a safety circuit with which only low voltage up to 48 V is provided until said robot is substantially fully docked, and which is switched to three-phase current only with full docking.

16. The system according to claim 2, wherein said feeding robot comprises variable speed electric drives controllable by frequency transformer for mixing elements, for driving and/or steering wheels and for a dispensing device.

17. The system according to claim 3, wherein said distributing robot comprises at least one variable speed electric drive controllable by at least one frequency transformer for driving and/or steering wheels.

18. The system according to claim 3, wherein either every mixing element comprises a separate variable-speed electric drive, or both mixing elements comprise a common electric drive for a drive train with a clutch between said mixing elements.

19. The system according to claim 3, wherein a control is provided for said mixing elements with which optionally only one of said mixing elements is or all are drivable and rotational speed-controlled in dependence of operating parameters provided by sensors, such as power consumption, filling weight, filling level, dispensing quantity per unit time.

20. The system according to claim 1, wherein said driving routes are predetermined by a guide rail network, preferably with switches, also with switches between linked power rail lines.

21. The system according to claim 1, wherein said power rail line is installed in a stationary manner substantially parallel to ground and slightly above a container of said robot.

22. A robot for systems for feeding livestock, in particular a feeding robot or a distributing robots, with a container disposed on a chassis with driving and/or steering wheels, a dispensing device, at least one battery charging device, an electric drive with a frequency transformer, a battery and at least one current collector for connecting to a power rail line, wherein said battery is a high-voltage DC battery and connected on the output side to an intermediate circuit of said at least one frequency transformer.

23. The robot according to claim 22, wherein said high-voltage battery is a nickel/metal hydride battery or a lithium battery or a nickel-cadmium battery.

24. A livestock feeding system comprising:
a feed preparation area;
a plurality of stables having feeding lanes;
a power rail line placed in said feed preparation area and each of said plurality of stables, said power rail line running adjacent to the feeding lanes, said power rail line coupled to an alternating current power source of a power grid;
a docking device coupled to the alternating current power source coupled to said power rail line in each of said plurality of stables and said feed preparation area;
drive route sections separating the feed preparation area and said plurality of stables;
a feeding robot comprising a feed container, a battery, an electric drive, a current collector, and a frequency transformer, said frequency transformer comprising an alternating current primary selectively coupled to the alternating current power source of the power grid, a direct current intermediate circuit coupled to the battery, and an alternating current secondary circuit coupled to the electric drive, wherein the current collector docks with the docking device coupling the frequency transformer with said power rail line and the alternating current power source when said feeding robot travels along said power rail line and the current collector decouples from the alternating current power source when said feeding robot travels on said drive route sections separating the feed preparation area and said plurality of stables; and
wherein the alternating current primary of the frequency transformer charges the battery and drives the electric drive of the feeding robot when coupled to the alternating current power source of the power grid coupled to the power rail line and the alternating current secondary coupled to the battery drives the electric drive of the feeding robot when traveling along the drive route sections separating the feed preparation area and said plurality of stables,
whereby said feeding robot autonomously drives under power from the battery when on said drive route sections and under power from the alternating current power source when on said power rail line.
